(19) United States
(12) Patent Application Publication
(10) Pub. No.: US 2010/0156165 A1
(43) Pub. Date: Jun. 24, 2010

(54) SEAT TIGHTENING MECHANISM FOR CHILD SAFETY SEAT

(76) Inventor: Philip Vais, Powell, OH (US)

Correspondence Address: Emerson, Thomson & Bennett, LLC, 777 W. Market Street, Akron, OH, 44303, US

(21) Appl. No.: 12/644,465

(22) Filed: Dec. 22, 2009

Related U.S. Application Data
(60) Provisional application No. 61/139,893, filed on Dec. 22, 2008.

(51) Int. Cl. B60N 2/44

(52) U.S. Cl. 297/463.1; 254/120; 254/108; 24/68 R

(57) ABSTRACT

This invention relates to mechanisms and systems for securing a child safety seat to a vehicle seat. Some embodiments include one or more movable anchoring structures. The anchoring structures can be connected to a rotatable member that is capable of exposing and retracting the movable anchoring structures. The rotatable member can also be connected to one or more lever members disposed at one or both ends of the rotatable member and capable of hand operation.

### CROSS-REFERENCE TO RELATED APPLICATIONS

This application claims the benefit of U.S. Provisional Application No. 61/139,893 titled SEAT TIGHTENING MECHANISM FOR CHILD SAFETY SEAT, filed Dec. 22, 2008, which is incorporated herein by reference.

### I. BACKGROUND OF THE INVENTION

A. Field of Invention

This invention relates to mechanisms and systems for securing a child safety seat to a vehicle seat.

B. Description of the Related Art

Devices and systems for securing child safety seats to automobile seats are known in the art. One such system uses stationary anchor points that are buried in the crease between a seat and seat back. According to this prior art the anchor points need to be buried for the comfort of persons sitting in the seat. Thus, in order to attach safety straps to the anchor points the seat and/or seat back needs to be compressed so as to expose the anchor points. This requires considerable force and can be difficult for some people.

The present invention provides mechanisms and systems for securing a child safety seat to a vehicle seat, which do not require compression of the seat or seat back to expose the anchor points.

### II. SUMMARY OF THE INVENTION

Some embodiments of the present invention relate to a seat tightening mechanism, comprising a rotatable member having a first end and a second end spaced apart from the first end defining a longitudinal rotational axis; at least one anchor member having a first end connected to the rotatable member, a second end connected to the rotatable member, and a portion between the first end and the second end defining a gap between the anchor member and the rotatable member; and at least one lever member connected to the rotatable member and extending away from the longitudinal rotational axis.

Other embodiments of the present invention relate to a system for installing a child safety seat, comprising a rotatable member having a first end and a second end spaced apart from the first end defining a longitudinal rotational axis, the rotatable member comprising a lower portion of a child safety seat installation system; at least one anchor member having a first end connected to the rotatable member, a second end connected to the rotatable member, and a portion between the first end and the second end defining a gap between the anchor member and the rotatable member, the at least one anchor member being adapted to receive a lower tethering means in a secure relation; at least one lever member connected to the rotatable member and extending away from the longitudinal rotational axis; and an upper anchor member disposed at a location above the rotational member and adapted to receive an upper tethering means in a secure relation, the upper anchor member comprising an upper portion of a child safety seat installation system.

Still other embodiments of the present invention relate to a seat tightening mechanism, comprising an anchoring means for anchoring a child safety seat to a vehicle seat with a tethering means; a force-accepting means for accepting an applied force and converting the applied force into a torque for rotating the anchoring means about an axis; and a torque-transferring means for transferring torque from the force accepting means to the anchoring means.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic drawing of an embodiment of the present invention.

FIG. 2 is a schematic drawing showing the embodiment of FIG. 1 installed in a vehicle seat.

### IV. DETAILED DESCRIPTION OF THE INVENTION

As used herein the term “integral” as used alone and in phrases such as “integrally disposed” include relations where a single body comprises a plurality of continuous components. For example, a single continuous body of polymer that is molded to form two or more distinct components. Accordingly, “integrally disposed” components include continuous rather than discrete components. As used herein the terms “attached” and “affixed” include relations where two or more discrete components are brought together as a single body, for example, through bonding or fastening. As used herein the term “disposed” as used alone or in phrases such as “disposed on” includes relations, such as but not limited to affixed, attached, and integral. As used herein the term “connected” includes relations such as affixed, attached, and integral.

The present invention generally relates to devices and methods for installing a child safety seat in a vehicle. In one embodiment, the present invention relates to an article for tightening one or more belts securing a child safety seat to a vehicle seat.

According to one embodiment, a device within the scope of the present invention comprises a rotatable member, having a lever located at one or more ends. According to this embodiment, the rotatable member also includes one or more anchor members along its length. The anchor members are adapted to receive an anchoring means, such as a hook. The anchoring means may be a part of a tethering means such as a belt, strap or cord.

In some embodiments the rotatable member is elongate, having a first end and a second end spaced apart from the first end and defining a longitudinal axis. The rotatable member can have any of a variety of cross sectional shapes perpendicular to the longitudinal axis. For example, suitable shapes include, without limitation, circular, oval, triangular, rectangular, pentagonal, hexagonal, heptagonal, octagonal, higher polygons, and the like or any combination thereof. Furthermore, in some embodiments the rotatable member can comprise any of a variety of materials including, without limitation, metals, alloys, organic polymers, ceramics, composites, and the like or any combination thereof. According to some embodiments, the rotatable member can comprise a solid structure, a hollow structure, or a structure having solid portions and hollow portions.

According to some embodiments a lever can be disposed at either end of the rotatable member or at both ends of the rotatable member. The lever can extend away from the longitudinal axis at an angle less than 180 degrees and greater than 0 degrees relative to the longitudinal axis of the rotatable member. According to some embodiments the lever can extend away from the longitudinal axis at an angle from greater than about 0 degrees to less than about 180 degrees, from about 10 to about 170 degrees, from about 20 to about 160 degrees, from about 30 to about 150 degrees, from about 40 to about 140 degrees, from about 50 to about 130 degrees, from about 60 to about 120 degrees, from about 70 to about 110 degrees, from about 80 to about 100 degrees, or from about 85 to about 95 degrees. Here, as elsewhere in the specification and claims, ranges may be combined.

According to some embodiments, the lever can comprise the same material as the rotatable member or a different material. Suitable materials include, without limitation, metals, alloys, organic polymers, ceramics, composites, and the like or any combination thereof. Furthermore, in some embodiments the lever may be integrally connected to the rotatable member. For example, the lever and the rotatable member may form continuous portions of the same molded part. In other embodiments, the lever may be fastened or otherwise affixed to the rotatable member. For example, suitable fastening means include, without limitation, bolts, screws, rivets, pins, snap fits, and the like or any combination thereof. Additionally, suitable means of otherwise affixing the lever to the rotatable member include, without limitation, welding, brazing, bonding and the like, or any combination thereof.

In some embodiments the one or more anchor members can comprise any of a variety of structures suitable for receiving a mateable anchor in a fixed relation. In one embodiment the anchor member comprises a structure having at least a first end and a second end. The first end connects to the rotatable member at a first point between the ends of the rotatable member. The second end of the anchor member connects to the rotatable member at a second point between the ends of the rotatable member and spaced apart from the first point. However, one of skill in the art will appreciate that a variety of structures can perform this same function, and are therefore within the scope of the present invention.

The at least one anchor member can have any of a variety of orientations relative to the longitudinal axis of the rotatable member. For example, in some embodiments an anchor member can be connected to the rotatable member in a fixed relation. In these embodiments an anchor member can extend away from the longitudinal axis and/or surface of the rotatable member in a direction that is approximately perpendicular, oblique or tangential relative to the longitudinal axis and/or to the surface of the rotatable member. In other embodiments the at least one anchor member can be connected to the rotatable member in a pivotable or hinged relation. According to such embodiments, the anchor member can have any orientation within the range of motion of the pivoting means or hinge. For example, in some embodiments the range of motion can be between perpendicular and tangential relative to the longitudinal axis and/or surface of the rotatable member. In other embodiments, the range of motion relative to the longitudinal axis and/or surface of the rotatable member can be between about 0 and 180 degrees, about 10 and 170 degrees, about 20 and 160 degrees, about 30 and 150 degrees, about 40 and 140 degrees, about 50 and 130 degrees, about 60 and 120 degrees, about 70 and 110 degrees, about 80 and 100 degrees, or about 85 and 95 degrees.

The at least one anchor member can have any of a variety of orientations relative to the longitudinal axis of the rotatable member. For example, in some embodiments an anchor member can be connected to the rotatable member in a fixed relation. In these embodiments an anchor member can extend away from the longitudinal axis and/or surface of the rotatable member in a direction that is approximately perpendicular, oblique or tangential relative to the longitudinal axis and/or to the surface of the rotatable member. In other embodiments the at least one anchor member can be connected to the rotatable member in a pivotable or hinged relation. According to such embodiments, the anchor member can have any orientation within the range of motion of the pivoting means or hinge. For example, in some embodiments the range of motion can be between perpendicular and tangential relative to the longitudinal axis and/or surface of the rotatable member. In other embodiments, the range of motion relative to the longitudinal axis and/or surface of the rotatable member can be between about 0 and 180 degrees, about 10 and 170 degrees, about 20 and 160 degrees, about 30 and 150 degrees, about 40 and 140 degrees, about 50 and 130 degrees, about 60 and 120 degrees, about 70 and 110 degrees, about 80 and 100 degrees, or about 85 and 95 degrees.

Some embodiments can also include a fixing means for fixing the rotatable member in a selected position. For instance, in some embodiments the rotatable member can be fixed in a position that maintains tension in a tethering means. Some structures that can comprise the fixing means, can include, without limitation, a ratchet mechanism, a tooth and pawl mechanism, a latching mechanism, a hooking mechanism, and the like or any combination thereof. One of skill in the art will recognize that a variety of structures can perform this same function, and are therefore within the scope of the present invention.

According to some embodiments, other fixing means can fix the position of the rotatable member in a tensioned configuration. For example, the rotatable member may be in a spring loaded relation, so that the rotatable member is normally held in a position that would apply tension to an attached tethering means. The user must apply a force to the lever member to move the rotatable member into a position for releasing or accepting a tethering means. One way that such a spring-loaded relation could be formed is through the use of a torsion spring applying a torque along the longitudinal axis of the rotatable member and biased in the tensioning direction. One of skill in the art will recognize that a variety of mechanisms and devices are capable of performing equivalently and are therefore within the scope of the present invention.

According to one embodiment, an article consistent with the foregoing description can be installed in a vehicle seat. For instance the rotatable member can be placed at or in the junction of a seat back with a seat. In some embodiments, the rotatable member can be recessed into the junction so that a person using the seat will not contact the rotatable member or the one or more anchor members. Furthermore, in some embodiments a lever member can be disposed at one or more sides of the seat. For instance, a seat can have a lever on a right side, on a left side, or on both a right and left side.

Some embodiments can comprise a system for securely installing a child safety seat in a vehicle seat. Such a system can comprise a rotatable member, lever member and at least one lower anchor member as described above. According to these embodiments, the foregoing structures are adapted to receive a lower tethering means, such as a seat belt strap having a hook at one or more ends. For example, one end of the lower tethering means may be connected to a region of the child safety seat below the center of mass of the safety seat, and another end may be attachable to a lower anchoring member. Additionally, such a system can comprise an upper anchor member. The upper anchor member can be adapted to receive an upper tethering means, such as a seat belt strap having a hook at one or more ends. For example, one end of the strap can be connected to the child safety seat at a point above the center of mass of the safety seat, while another end can be attached to the upper anchor member. Some embodiments may also include a means for tensioning an upper tethering member. One of skill in the art will recognize that a variety of known structures are capable of performing this function and are therefore within the scope of the present invention.

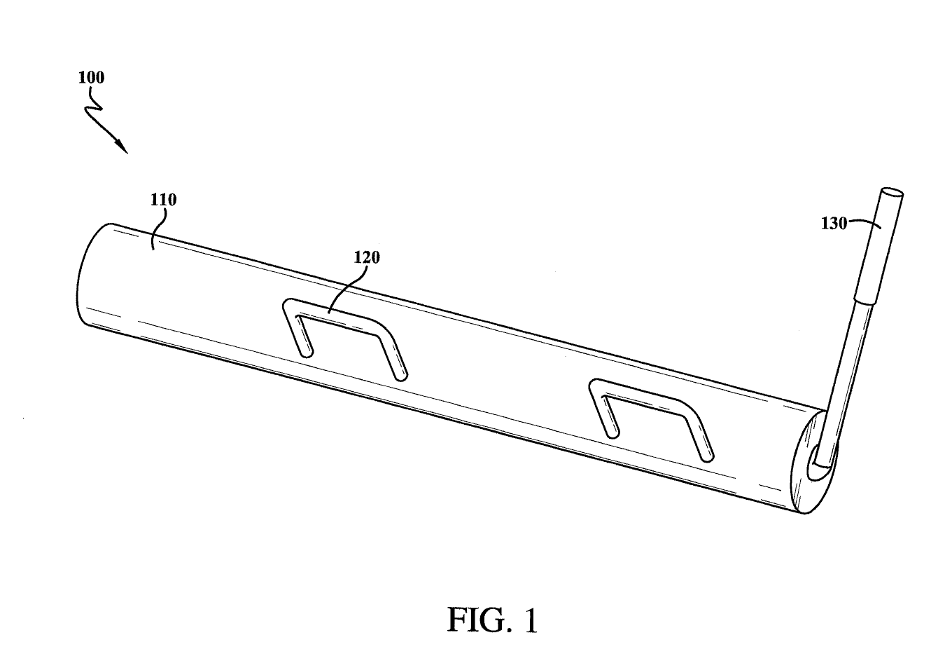

Referring now to the drawings wherein the showings are for purposes of illustrating embodiments of the invention only and not for purposes of limiting the same, FIG. 1 is a schematic drawing of an embodiment 100 of the present invention. This specific embodiment comprises an elongate rotatable member 110, having several anchor members 120, and a lever member 130 at one end. In this example, the lever is oriented at about 90 degrees relative to the longitudinal axis of the rotatable member.

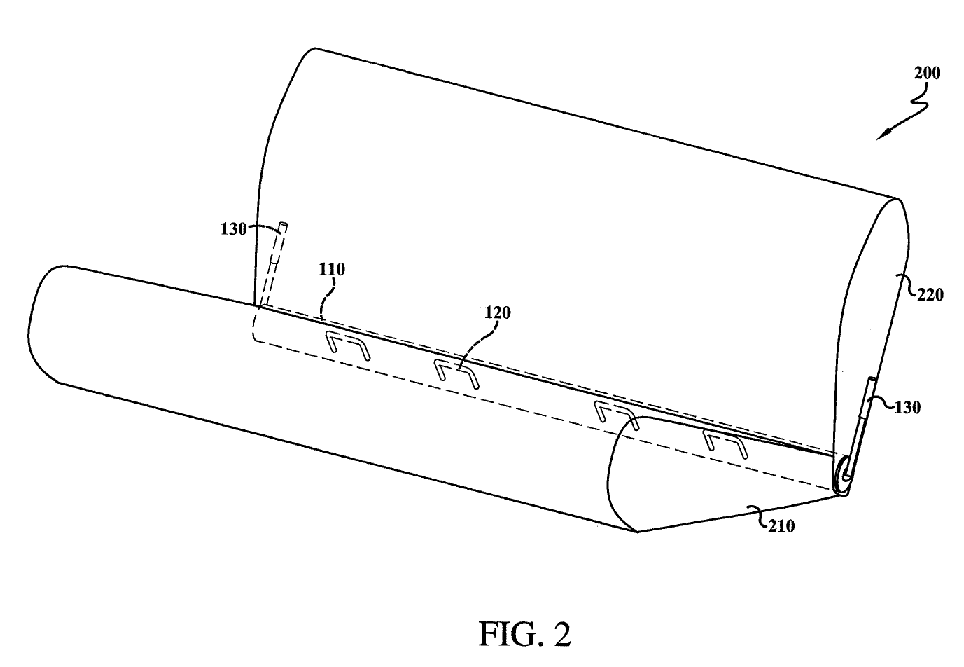

FIG. 2 shows an embodiment 200 where the embodiment 100 of FIG. 1 is installed in a vehicle seat. The rotatable member 110 is disposed in the junction between a seat back 220 and a seat 210. Lever members 130 are disposed at both the left and right side of the embodiment 200. Therefore, a user can secure a child safety seat, to the vehicle seat by turning the rotatable 110 member using either of the lever members 130, so that the anchor members 120 are exposed and accessible to a tethering means. The user can then mate the tethering means with one or more anchor members 120, and move the lever member 130 so as to tension the tethering means.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A seat tightening mechanism, comprising:
a rotatable member having a first end and a second end spaced apart from the first end defining a longitudinal rotational axis;
at least one anchor member having a first end connected to the rotatable member, a second end connected to the rotatable member, and a portion between the first end and the second end defining a gap between the anchor member and the rotatable member; and
at least one lever member connected to the rotatable member and extending away from the longitudinal rotational axis.

2. The mechanism of claim 1, wherein the rotatable member, the at least one anchor member and the at least one lever member comprise a single molded part.

3. The mechanism of claim 1, wherein the at least one anchor member is affixed to the rotatable member by a method selected from the group consisting of welding, brazing, and fastening.

4. The mechanism of claim 1, wherein the at least one anchor member is oriented at an angle from about 0 degrees to about 180 degrees relative to the longitudinal axis of the rotatable member.

5. The mechanism of claim 3, wherein the method of fastening is selected from the group consisting of bolting, riveting, and screwing.

6. The mechanism of claim 1, wherein the anchor member is attached to the rotatable member in a pivotable relation.

7. The mechanism of claim 6, wherein the pivotable relation is due to a hinged structure.

8. The mechanism of claim 7, wherein the hinged structure imparts a range of motion to the anchor member that is from about 0 to about 180 degrees relative to the longitudinal axis of the rotatable member.

9. The mechanism of claim 1, wherein the at least one lever member is affixed to the rotatable member by a method selected from the group consisting of welding, brazing, and fastening.

10. The mechanism of claim 9, wherein the method of fastening is selected from the group consisting of bolting, riveting, and screwing.

11. The mechanism of claim 1, further comprising a ratcheting mechanism in rotational communication with the rotatable member and the at least one lever member, and adapted to restrict the rotation of the rotatable member to one direction.

12. The mechanism of claim 11, wherein the ratcheting mechanism comprises at least one set of ratchet teeth disposed about a perimeter of the rotatable member, and at least one pawl member in a reversibly engageable relation with the at least one set of ratchet teeth.

13. The mechanism of claim 12, wherein the ratcheting mechanism further comprises a pawl-disengagement member in lifting communication with the pawl of the ratchet and adapted to lift the pawl from the ratchet teeth and disengage the ratchet.

14. The mechanism of claim 1, wherein the rotatable member is disposed between a seat and a seat-back of a vehicle seat.

15. The mechanism of claim 1, wherein one or more of the rotatable member, the at least one lever member or the at least one anchor member comprise a material selected from the group consisting of organic polymer, a metal, an alloy, a composite material, and a fiberglass material.

16. A system for installing a child safety seat, comprising:
a rotatable member having a first end and a second end spaced apart from the first end defining a longitudinal rotational axis, the rotatable member comprising a lower portion of a child safety seat installation system;
at least one anchor member having a first end connected to the rotatable member, a second end connected to the rotatable member, and a portion between the first end and the second end defining a gap between the anchor member and the rotatable member, the at least one anchor member being adapted to receive a lower tethering means in a secure relation;
at least one lever member connected to the rotatable member and extending away from the longitudinal rotational axis; and
an upper anchor member disposed at a location above the rotational member and adapted to receive an upper tethering means in a secure relation, the upper anchor member comprising an upper portion of a child safety seat installation system.

17. A seat tightening mechanism, comprising: an anchoring means for anchoring a child safety seat to a vehicle seat with a tethering means; a force-accepting means for accepting an applied force and converting the applied force into a torque for rotating the anchoring means about an axis; and a torque-transferring means for transferring torque from the force accepting means to the anchoring means.
